(19) United States
(12) Patent Application Publication
(10) Pub. No.: US 2020/0300001 A1
(43) Pub. Date: Sep. 24, 2020

(54) AIRCRAFT DOOR LATCH APPARATUS AND RELATED METHODS FOR USE OF THE SAME

(71) Applicant: Harper Engineering Co., Renton, WA (US)

(72) Inventor: David Chadwell, Renton, WA (US)

(21) Appl. No.: 16/782,396

(22) Filed: Feb. 5, 2020

Related U.S. Application Data
(60) Provisional application No. 62/821,875, filed on Mar. 21, 2019.

(51) Int. Cl. E05B 47/00; B64C 1/14; E05B 41/00; E05B 57/00; E05B 7/00

(52) U.S. Cl. CPC E05B 47/0002; E05B 47/0047; E05B 7/00; E05B 41/00; E05B 57/00; B64C 1/1407

(57) ABSTRACT

An aircraft door latch apparatus having a latched configuration and an unlatched configuration can include a door structure of an aircraft door assembly, a handle coupled to the door structure and pivotably moveable with respect to the door structure between a latched position and an unlatched position, the handle including at least a first wall and a handle cavity, and a latch apparatus coupled to the handle. The latch apparatus may be operable to move the handle between the latched position and the unlatched position, the latch apparatus received in the handle cavity and arranged to be concealed by the handle when the aircraft door latch apparatus is in the latched configuration and the unlatched configuration. Related methods are also provided.

### BACKGROUND

### Technical Field

The present disclosure generally relates to aircraft interior components and, more particularly, to aircraft interior component latch assemblies.

### Description of the Related Art

Aircraft generally include a wide variety of interior components. Aircraft interior components, for example, galley doors, passenger service units, lavatory doors, galleys, closets, and other interior furnishings generally are moveable between open and closed positions. In general, such interior furnishings may include a door jamb or frame having a strike component and a latch mechanism provided on a door that latches the door to the strike component.

Conventional aircraft interior components tend to expose one or more latch mechanism components, which results in an unsightly, aesthetically displeasing interior component. Furthermore, it is generally desirable to indicate to users whether the interior component has latched to the door frame or is unlatched, in an efficient manner.

### BRIEF SUMMARY

The various implementations of aircraft door latch apparatuses described herein provide apparatuses that conceal various components of latch apparatus of the aircraft door latch apparatus in both latched and unlatched configuration. The various implementations of aircraft door latch apparatuses described herein provide efficient, compact, and robust forms of indicating latched and/or unlatched configurations of the aircraft door latch apparatuses. For example, in one non-limiting, example implementation, an aircraft door latch apparatus having a latched configuration and an unlatched configuration can be summarized as including a door structure of an aircraft door assembly, a handle coupled to the door structure and pivotably moveable with respect to the door structure between a latched position and an unlatched position, the handle including at least a first wall and a handle cavity, and a latch apparatus coupled to the handle. The latch apparatus may be operable to move the handle between the latched position and the unlatched position, the latch apparatus received in the handle cavity and arranged to be concealed by the handle when the aircraft door latch apparatus is in the latched configuration and the unlatched configuration.

In another non-limiting, example implementation, a method of operating an aircraft interior furnishing can be summarized as including latching an aircraft door assembly, the latching including magnetically coupling a latch apparatus coupled to a handle of the aircraft door assembly to a door strike coupled to a door frame of the aircraft interior furnishing; and unlatching the aircraft door assembly. The unlatching can include magnetically uncoupling the latch apparatus from the door strike, moving an indicator element of the latch apparatus to expose an indicia surface of the indicator element, the indicia surface indicating an unlatched configuration, and rotatably moving the aircraft door assembly to expose an interior of the interior furnishing.

### BRIEF DESCRIPTION OF THE SEVERAL VIEWS OF THE DRAWINGS

FIG. 1 is an isometric view of an aircraft door latch apparatus, according to one example, non-limiting implementation.

FIG. 2A is an exploded view of the aircraft door latch apparatus of FIG. 1.

FIG. 2B is another exploded view of the aircraft door latch apparatus of FIG. 1.

FIG. 2C is a side view of a door structure of the aircraft door latch apparatus of FIG. 1.

FIG. 2D is a side isometric view of a handle of the aircraft door latch apparatus of FIG. 1.

FIG. 3 is a left side view of the aircraft door latch apparatus, with certain components, e.g., door structure, removed for clarity of illustration and description.

FIG. 4 is a right side view of the aircraft door latch apparatus, with certain components, e.g., handle, removed for clarity of illustration and description.

FIG. 5 is a cross-sectional view of the aircraft door latch apparatus of FIG. 1, taken along line 5-5.

FIG. 6 is a cross-sectional view of the aircraft door latch apparatus of FIG. 2A, taken along line 6-6.

FIG. 7 is a cross-sectional view of the aircraft door latch apparatus of FIG. 1, taken along line 7-7.

FIG. 8 is a cross-sectional view of the aircraft door latch apparatus of FIG. 1, taken along line 8-8.

### DETAILED DESCRIPTION

In the following description, certain specific details are set forth in order to provide a thorough understanding of various disclosed embodiments or implementations. However, one skilled in the relevant art will recognize that embodiments or implementations may be practiced without one or more of these specific details, or with other methods, components, materials, etc. In other instances, well-known structures associated with payload components, hinges, latches, aircraft interior furnishings, aircraft doors, aircraft frames, or other systems and apparatuses of aircrafts have not been shown or described in detail to avoid unnecessarily obscuring descriptions of the embodiments or implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment,” “one implementation,” “an embodiment,” or “an implementation” means that a particular feature, structure or characteristic described in connection with the embodiment or implementation is included in at least one embodiment or implementation. Thus, the appearances of the phrases “in one embodiment,” “in one implementation,” “in an embodiment,” or “in an implementation” in various places throughout this specification are not necessarily all referring to the same embodiment or implementation. Furthermore, the particular features, structures, or characteristics may be combined in any suitable manner in one or more embodiments or implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

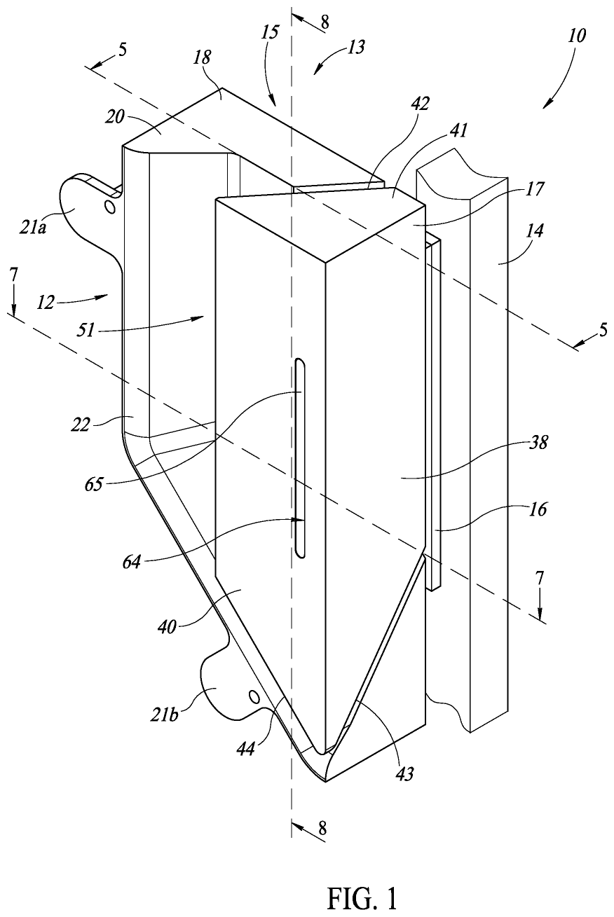

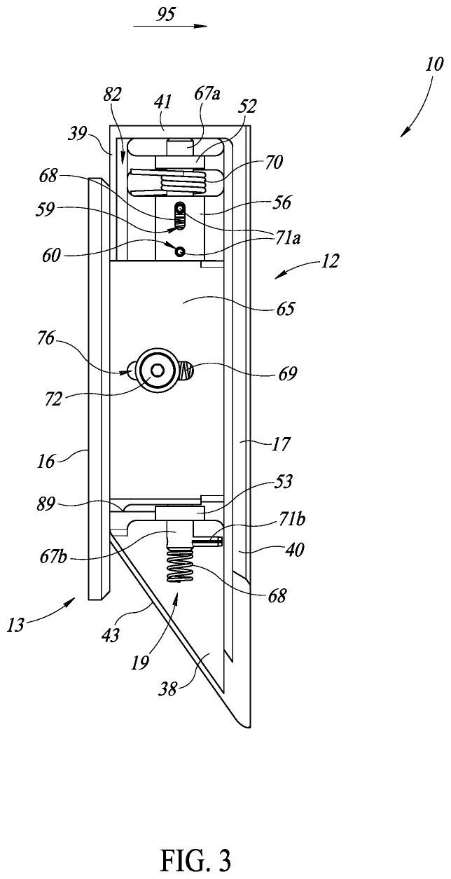

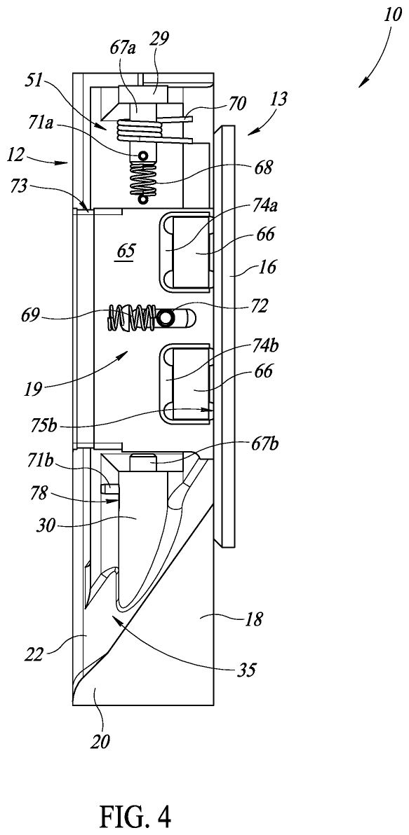

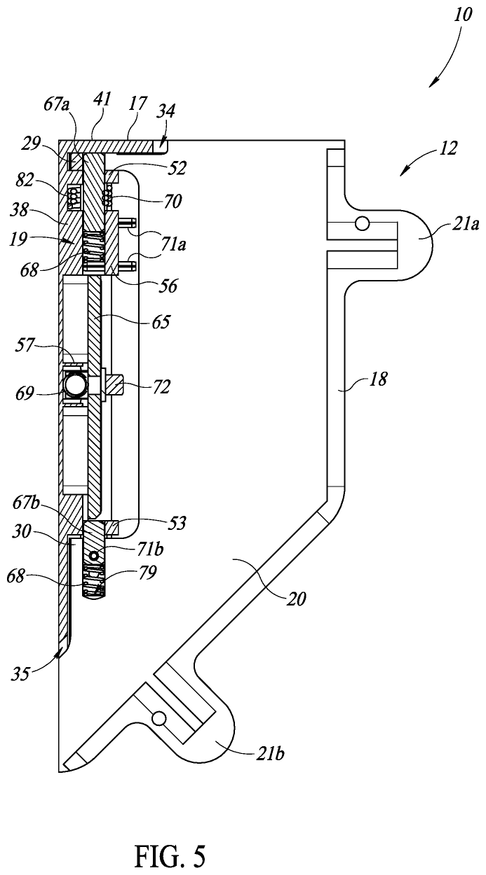

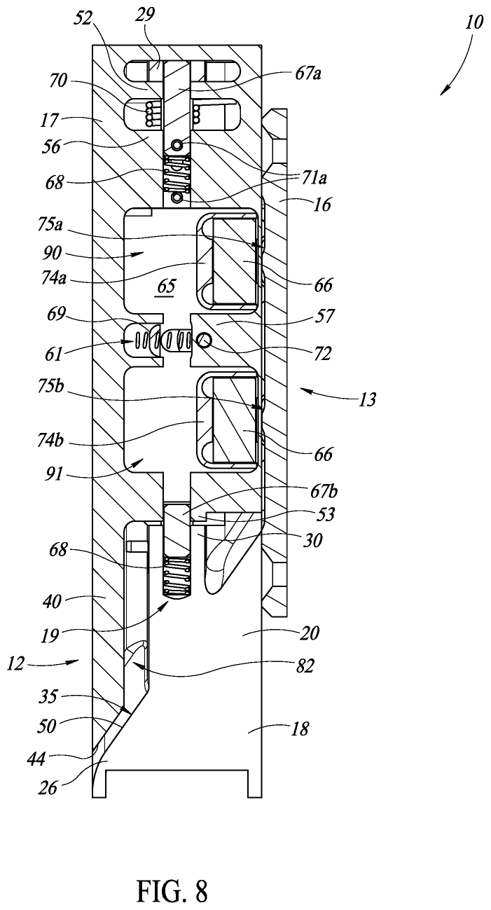

FIGS. 1-8 illustrate an aircraft door latch apparatus 10, according to one example, non-limiting implementation. The aircraft door latch apparatus 10 generally includes a door assembly 12 and a door frame assembly 13. The door frame assembly 13 includes a door frame or door jamb 14 having an opening 15 and a door strike 16. The door jamb 14 is generally coupled to an interior furnishing, with the opening 15 sized and shaped to provide access to an interior volume of the interior furnishing, as illustrated partially in FIG. 1, with the door jamb 14 removed in the other figures for clarity of description and illustration. The door strike 16 is coupled to the door jamb 14 and is generally configured to latch and/or unlatch the door assembly 12, as described in more detail below.

The door assembly 12 includes a handle 17, a door structure 18, and a latch assembly 19. Although not shown for clarity of illustration and description, the door structure 18 is generally sized and shaped to couple to a door panel of the door assembly 12. The overall door assembly 12 may be coupled to the door frame 14, for example, via hinges. The door assembly 12 may be rotatably moved between open and closed configurations to provide access to the interior volume of the interior furnishing and conceal or prevent access to the same. For example, the door structure 18 includes a main body 20 having at least a pair of coupling elements 21a, 21b. The coupling elements 21a, 21b are generally sized and shaped to couple to the door panel. The main body 20 of the door structure 18 includes a first flange 22 and a second flange 23 that is spaced apart from the first flange 22 to define a receiving cavity 51. The first flange 22 includes a first portion 24 that is angularly oriented relative to a horizontal axis 25 of the main body 20 at an angle α₁ and a second portion 26 that is also angularly oriented relative to a vertical axis 81 at an angle α₂. In this manner, the first portion 24 includes a first surface 27 that extends angularly, and the second portion 26 includes a second surface 28 that extends angularly. The second flange 23, however, is generally oriented to be parallel to the vertical axis 81. The second flange 23 includes a first clevis 29 and a second clevis 30 that are vertically spaced apart. In particular, both the first clevis 29 and the second clevis 30 extend outwardly relative to an outer surface 31 of the second flange 23. The first clevis 29 includes a first coupling aperture 32 and the second clevis 30 includes a second coupling aperture 33. The first and second coupling apertures 32, 33 are sized and shaped to pivotably couple the handle 17 to the door structure 18 via the latch assembly 19, as described in more detail below.

As illustrated in FIGS. 1-8, the main body 20 includes an upper recess 34 and a lower recess 35. The upper recess 34 is located proximal to the first clevis 29 and the lower recess 35 is positioned proximal to the second clevis 30. The upper and lower recesses 34, 35 are sized and shaped to allow the handle 17 to be pivotably coupleable to the door structure 18 to allow rotatable movement of the handle 17 and also concealing or covering the latch assembly 19 so as not to expose one or more components of the latch assembly 19.

The handle 17 includes a first wall 38, a second wall 39, a third wall 40, and an upper wall 41. The first, second, third, and upper walls 38, 39, 40, 41 are arranged to define an interior cavity 82 and a bevel edge 42. The first wall 38 includes a first chamfer edge 43 and the third wall 40 also includes a second chamfer edge 44. The upper and lower recesses 34, 35 of the main body 20 are sized and shaped to allow portions of the main body 20 to be received in the interior cavity 82 of the handle 17. In particular, the upper recess 34 allows the second flange 23 to be received in the interior cavity 82 with the upper wall 41 being substantially flush with the main body 20 and the lower recess 35 allows the second chamfer edge 44 to be oriented in substantial alignment with the second portion 26 of the first flange 22, with the second chamfer edge 44 in substantial alignment with an end edge 50 of the main body 20. Thus, when the handle 17 is pivotably coupled to the door structure 18, the handle 17 is positioned in the receiving cavity 51 of the door structure 18, with certain portions of the door structure 18 extending into and being received in the interior cavity 82 of the handle 17 to conceal or cover the latch assembly 19.

As described above, the aircraft door latch apparatus 10 is generally sized, shaped, and arranged to allow the various components of the latch assembly 19 to not be exposed. In particular, an interior of the first wall 38 includes various structural features that allow the components of the latch assembly 19 to be received therein. The first wall 38 includes a first wall element 52 and a second wall element 53 spaced apart in the vertical direction. Each of the first and second wall elements 52, 53 include respective pin apertures 54, 55. The pin apertures 54, 55 are sized and shaped to align with the respective first coupling aperture 32 of the first clevis 29 and the second coupling aperture 33 of the second clevis 30.

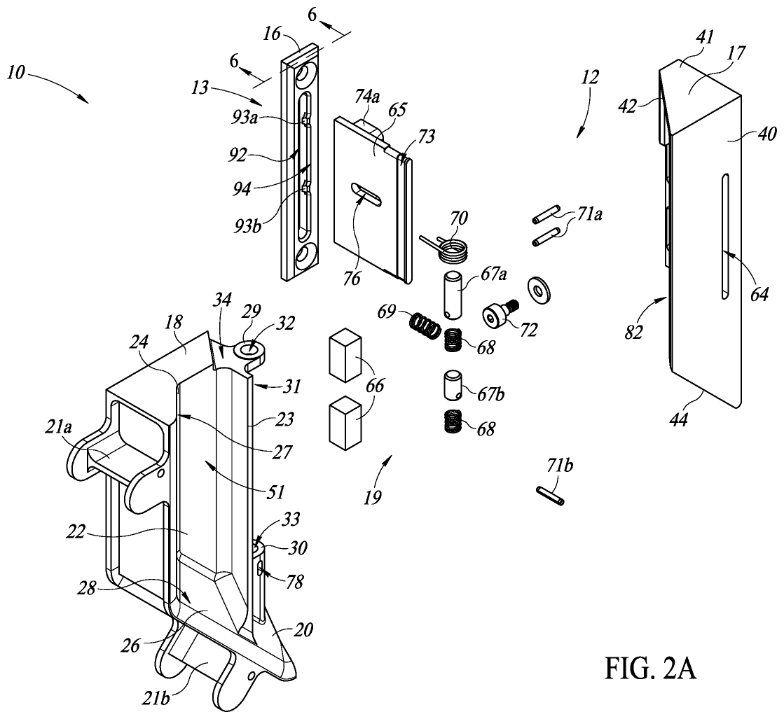

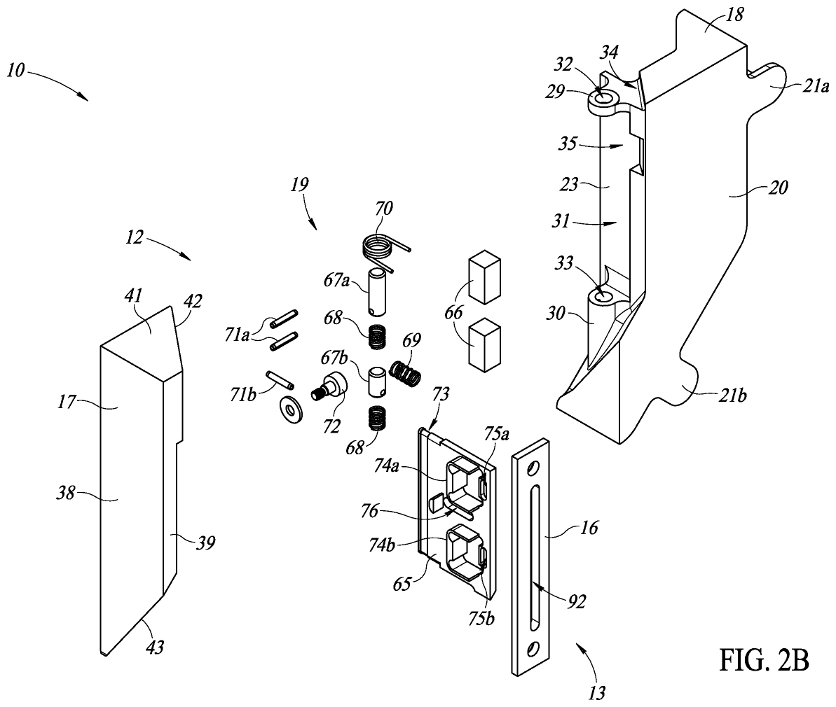

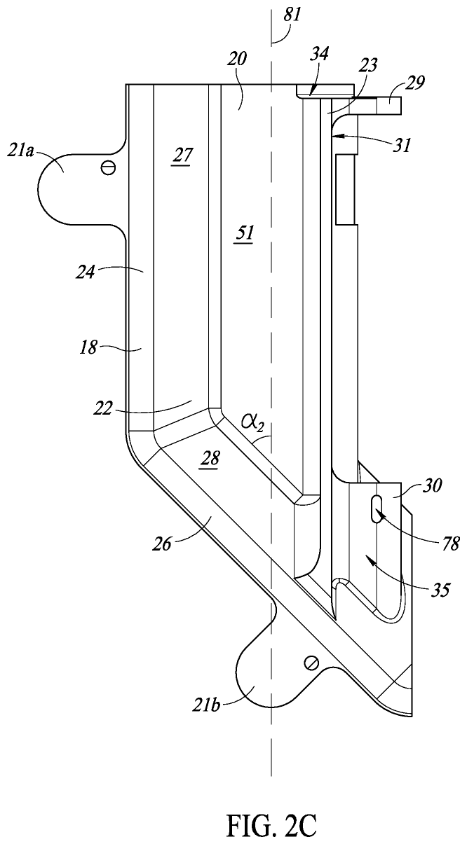

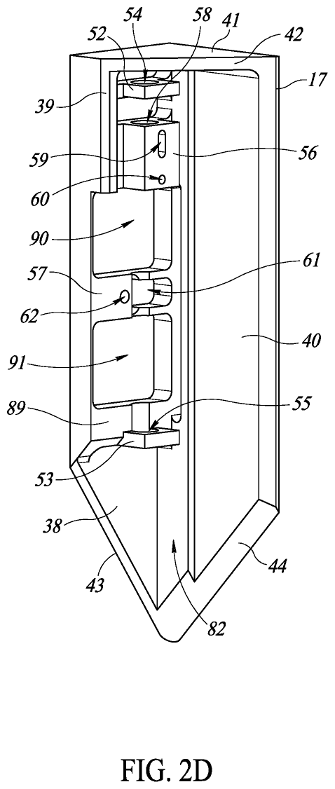

The first wall 38 includes a coupling element 56 and an indicator portion 57. The coupling element 56 includes a coupling aperture 58 that is sized and shaped to align with the pin aperture 54 of the first wall element 52. The coupling element 56 also includes a slot aperture 59 and a coupling pin aperture 60. The indicator portion 57 includes a spring recess 61 and a fastener aperture 62. The first wall 38 also includes a lower tab element 89 positioned adjacent to the second wall element 53. As illustrated in FIG. 2D in more detail, the first wall 38 includes a first magnet recess 90 and a second magnet recess 91. The first magnet recess 90 is positioned between the coupling element 56 and the indicator portion 57. The second magnet recess 91 is positioned between the indicator portion 57 and the lower tab element 89. The third wall 40 includes an indicator recess 64 that is elongated, for example, in the form of a slot. The indicator recess 64 is sized and shaped to slideably receive an indicator element 65 of the latch assembly 19.

In particular, the latch assembly 19 includes the indicator element 65, one or more magnet elements 66, one or more coupling pins 67a, 67b, one or more first biasing elements 68, a second biasing element 69, a third biasing element 70, one or more retention pins 71a, 71b, and a magnet fastener 72. The indicator element 65 is generally sized and shaped to be slideably moveable through the indicator recess 64. The indicator element 65 includes an indicia surface 73 that generally indicates if the aircraft door latch apparatus 10 is latched or unlatched. For example, the indicia surface 73 can comprise a bright color that is different from the color of the other surfaces of the indicator element 65. For example, as the indicator element 65 moves out of, or away from, the indicator recess 64, the indicia surface 73 is exposed to indicate that the aircraft door latch apparatus 10 is in the unlatched configuration. Conversely, when the aircraft door latch apparatus 10 is in a latched configuration, the indicia surface 73 is covered or concealed, indicative of a latched configuration.

The indicator element 65 includes a pair of retention portions 74a, 74b that are spaced apart and sized, shaped, and arranged to receive therein the one or more magnet elements 66. Proximate to each retention portion 74a, 74b, the indicator element 65 includes latch apertures 75a, 75b. As described in more detail below, each latch aperture 75a, 75b is sized and shaped to receive therein portions of the door strike 16 to latch and/or unlatch the aircraft door latch apparatus 10. The indicator element 65 includes a biasing element aperture 76 that is generally elongated, e.g., in a form of a slot. The biasing element aperture 76 is sized and shaped to slideably receive therein the magnet fastener 72. In particular, the second biasing element 69 is sized and shaped to be received in the spring recess 61 of the handle 17. The magnet fastener 72 is sized and shaped to be received in the biasing element aperture 76 and the fastener aperture 62 of the handle 17. In particular, the indicator element 65 is sandwiched between a head of the magnet fastener 72 and the first wall 38 of the handle 17 and positioned adjacent to the second biasing element 69. In this manner, the indicator element 65 is slideably moveable relative to the handle 17 and rotatably moveable with the handle 17. In particular, the second biasing element 69 is sized and shaped to urge the indicator element 65 away from, or out of, the indicator recess 64 of the third wall 40, with the indicator element 65 being slideably moveable relative to the magnet fastener 72 within the biasing element aperture 76.

The one or more coupling pins 67a, 67b are sized and shaped to pivotably couple the handle 17 to the door structure 18. In particular, the coupling pin 67a is received in the first coupling aperture 32 of the first clevis 29 and the pin aperture 54 disposed in the first wall element 52 of the handle 17. In addition, the coupling pin 67b is received in the second coupling aperture 33 of the second clevis 30 and the pin aperture 55 disposed in the second wall element 53 of the handle 17.

As illustrated in FIGS. 1-8, the coupling pin 67a extends through the third biasing element 70. In particular, the third biasing element 70 is positioned between the coupling element 56 and the first wall element 52, with the coupling pin 67a extending through the coupling element 56 and the third biasing element 70. In some implementations, the third biasing element 70 may comprise a torsion spring. In particular, the third biasing element 70 is sized and shaped to rotatably urge the handle 17 to the latched configuration. For example, if the handle 17 is moved from the latched position to the unlatched position by rotary movement thereof in a counterclockwise direction, the third biasing element 70 generally urges to rotatably move the handle 17 to the latched position by rotary movement in a clockwise direction.

The retention pins 71a protrude outwardly in a perpendicular orientation relative to the shaft of the coupling pin 67a. In particular, one of the retention pins 71a is coupled to the coupling pin 67a and protrudes outwardly from the slot aperture 59 of the coupling element 56. Another one of the retention pins 71a protrudes outwardly from the coupling pin aperture 60 of the coupling element 56. One of the one or more first biasing elements 68 is positioned adjacent to an end of the shaft of the coupling pin 67a and a lower one of the retention pins 71a. In this manner, the retention pins 71a and the first biasing element 68, e.g., a spring, facilitate alignment of the handle 17, the indicator element 65, and the door structure 18. Similarly, the retention pin 71b protrudes outwardly from the coupling pin 67b toward the third wall 40 and into an alignment slot 78 disposed in the main body 20 of the door structure 18. Another one of the one or more first biasing elements 68 is positioned between an end of the shaft of the coupling pin 67b and a spring coupling surface 79 disposed in the main body 20 of the door structure 18. Again, in this manner, the retention pin 71b and the first biasing element 68 facilitate alignment of the handle 17, the indicator element 65, and the door structure 18.

As described above, the aircraft door latch apparatus 10 moves between a latched and/or an unlatched configuration. In particular, the door strike 16 receives the indicator element 65 to latch the aircraft door latch apparatus 10. The door strike 16 includes a strike recess 92 extending therethrough. A pair of tab elements 93a, 93b protrude outwardly from a strike surface 94 positioned at one end of the strike recess 92. The strike recess 92 is sized and shaped to receive therein the indicator element 65 and facilitate movement of the indicator element 65. The tab elements 93a, 93b are sized and shaped to be received in the latch apertures 75a, 75b when the aircraft door latch apparatus 10 is in the latched configuration.

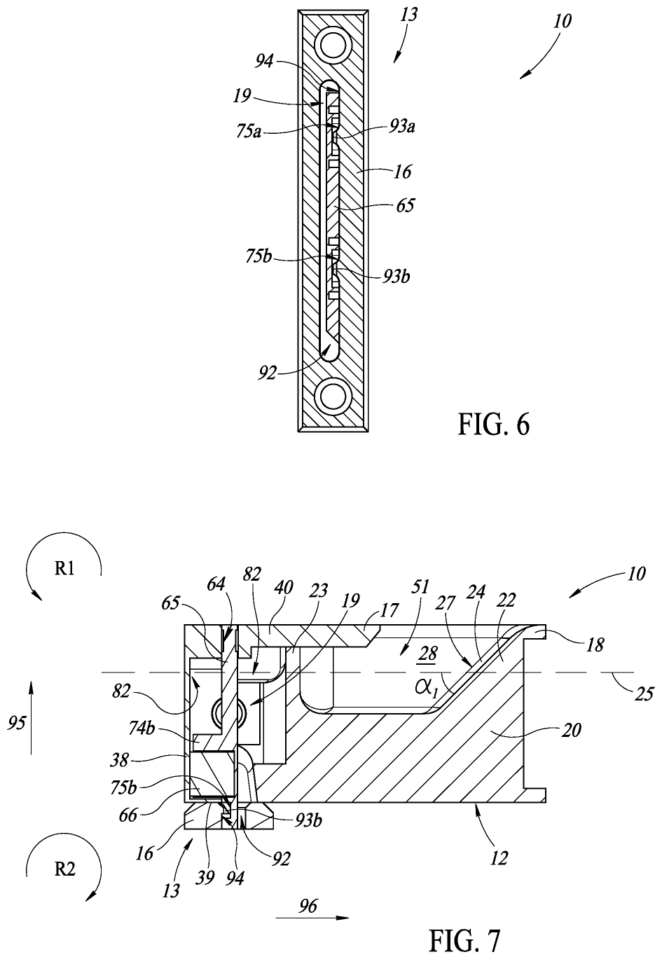

In particular, during operation, the aircraft door latch apparatus 10 may be moved between latched and unlatched configurations. In the latched configuration, as shown in FIGS. 6 and 7 in detail, the tab elements 93a, 93b of the door strike 16 are received in the latch apertures 75a, 75b, and the indicator element 65 is positioned adjacent to, or in mating alignment with, the strike surface 94. With continued reference to FIGS. 1-8, the one or more magnet elements 66 received in the retention portions 74a, 74b of the indicator element 65 are positioned adjacent to the door strike 16. The one or more magnet elements 66 are magnetically coupled to the door strike 16, which may comprise a ferromagnetic material, such as steel. The magnetic forces of the one or more magnet elements 66 are attracted to the door strike 16, and counteract, and overcome biasing forces of the second biasing element 69 which urges the indicator element 65 to move out of the strike recess 92 and the indicator recess 64 of the third wall 40 in direction 95 to expose the indicia surface 73 of the indicator element 65.

To move the aircraft door latch apparatus 10 from the latched to the unlatched configuration, the handle 17 may be rotated in a first rotary direction R1, which as illustrated, may be a counterclockwise direction. In particular, the handle 17 may pivotably rotate with respect to the door structure 18 in the first rotary direction R1 via coupling pins 67a, 67b, which define respective pivot points. As the user applies rotary forces to move the handle 17 in the first rotary direction R1, such rotary forces overcome the biasing forces applied by the third biasing element 70, e.g., a torsion spring. As described earlier, the third biasing element 70 is generally sized and shaped to urge the handle 17 into the latched configuration, e.g., urging the third biasing element 70 to move in a second rotary direction R2, which may be a clockwise direction.

As the handle 17 is moved in the first rotary direction R1, the indicator element 65 moves within the strike recess 92 away from the strike surface 94 in direction 96. For example, a user may rotary handle 17 in first rotary direction R1, until the indicator element 65 moves away from the strike surface 94, which results in forces applied by the user to overcome the magnetic forces between the one or more magnet elements 66 and the door strike 16. Such movement moves the aircraft door latch apparatus 10 from the latched configuration to the unlatched configuration. In particular, as the indicator element 65 moves away from the strike surface 94, the tab elements 93a, 93b are moved out of the latch apertures 75a, 75b. As the magnetic forces between the one or more magnet elements 66 and the door strike 16 are reduced, the biasing forces of the second biasing element 69 are sufficient to move the indicator element 65 relative to the magnet fastener 72 and through the biasing element aperture 76, which moves the indicator element out of the indicator recess 64 of the third wall 40 and exposes the indicia surface 73. As the indicia surface 73 is exposed, such indicates to a user that the aircraft door latch apparatus 10 is in the unlatched configuration.

Thereafter, the handle 17 may be rotated in the second rotary direction R2, which may be a clockwise direction. Rotary movement of the handle 17 in the second rotary direction R2 causes the handle 17 to rotate with the door structure 18 in the second rotary direction R2. In particular, as the door structure 18 and the handle 17 moves in the second rotary direction R2, the aircraft door coupled to the door structure 18 may move from a closed position to an open position. As the door structure 18 is moved to the open position, and the handle 17 is released by the user, the biasing forces of the third biasing element 70 urge the handle 17 to rotatably move in the second rotary direction R2 toward a position similar to the position of the handle 17 in the latched configuration illustrated in FIGS. 1 and 4-8. However, as the indicator element 65 is away from the door strike 16, the indicator element 65 remains in a position similar to the position of the indicator element 65 in the unlatched configuration. In other words, the indicia surface 73 of the indicator element 65 remains exposed due to the biasing forces of the second biasing element 69.

Thereafter, the door structure 18 may be rotated in the first rotary direction R1, which moves with the handle 17. As the door structure 18 and the handle 17 are returned to the latched position, the indicator element 65 is positioned adjacent to the strike surface 94. In particular, as described above, the third biasing element 70 returns the handle 17 to a position similar to the position of the handle 17 in the latched configuration. In some implementations, the one or more magnet elements 66 may be sized and shaped to magnetically couple to the door strike 16 when the indicator element 65 is positioned adjacent to the strike surface 94 even if the indicator element 65 is not moved into the strike recess 92 of the door strike 16. In other words, the indicia surface 73 may be exposed as the indicator element 65 is moved out of the indicator recess 64 of the third wall 40. However, as the door structure 18 and the handle 17 are moved toward the door strike 16, the magnetic forces between the one or more magnet elements 66 and the door strike 16 move the indicator element 65 into the indicator recess 64 of the third wall 40 and into the strike recess 92 of the door strike 16 to return the aircraft door latch apparatus 10 to the latched configuration. In some implementations, however, the user may manually push the indicator element 65 as the door structure 18 and the handle 17 are moved toward the door strike 16.

Moreover, the various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An aircraft door latch apparatus having a latched configuration and an unlatched configuration, the aircraft door latch apparatus comprising:
a door structure of an aircraft door assembly;
a handle coupled to the door structure and pivotably moveable with respect to the door structure between a latched position and an unlatched position, the handle including at least a first wall and a handle cavity; and
a latch apparatus coupled to the handle and operable to move the handle between the latched position and the unlatched position, the latch apparatus received in the handle cavity and arranged to be concealed by the handle when the aircraft door latch apparatus is in the latched configuration and the unlatched configuration.

2. The aircraft door latch apparatus of claim 1 wherein the door structure includes a flange having a first coupling portion and a second coupling portion, the first and second coupling portion each having a coupling aperture sized and shaped to pivotably couple the door structure to the handle via respective pins.

3. The aircraft door latch apparatus of claim 1, further comprising:
a door strike sized and shaped to latch to the latch apparatus when the aircraft door latch apparatus is in the latched configuration and unlatch from the latch apparatus when the aircraft door latch apparatus is in the unlatched configuration.

4. The aircraft door latch apparatus of claim 3, wherein the latch apparatus comprises:
an indicator element having an indicia surface; and
one or more magnet elements sized and shaped to magnetically couple the indicator element to the door strike when the aircraft door latch apparatus is in the latched configuration.

5. The aircraft door latch apparatus of claim 4 wherein the door strike includes one or more coupling tabs and the indicator element includes one or more coupling apertures, the one or more coupling apertures sized and shaped to receive the one or more coupling tabs when the aircraft door latch apparatus is in the latched configuration.

6. The aircraft door latch apparatus of claim 4 wherein the door strike includes a door strike recess that is sized and shaped to:
slideably receive therein the indicator element; and
rotatably move therein the indicator element between opposing surfaces of the indicator element.

7. The aircraft door latch apparatus of claim 4 wherein the first wall of the handle includes a recess, the recess sized and shaped to slideably receive the indicator element.

8. The aircraft door latch apparatus of claim 7 wherein at least a portion of the indicator element slideably moves out of the recess to expose the indicia surface when the aircraft door latch apparatus is in the latched configuration.

9. The aircraft door latch apparatus of claim 8 wherein the latch apparatus includes a biasing element that is sized and shaped to urge the indicator element to slideably move out of the recess when the aircraft door latch apparatus is in the latched configuration.

10. The aircraft door latch apparatus of claim 1 wherein the handle includes a second wall that is oriented perpendicularly relative to the first wall, an interior side of the second wall including one or more coupling elements sized and shaped to receive the latch apparatus.

11. The aircraft door latch apparatus of claim 10 wherein the one or more coupling elements includes a pair of coupling tabs, a first one of the coupling tabs is arranged to be positioned adjacent to a first coupling portion of the door structure, and a second one of the coupling tabs is arranged to be positioned adjacent to a second coupling portion of the door structure.

12. The aircraft door latch apparatus of claim 10 wherein one of the one or more coupling elements includes an indicator portion having a spring recess that is sized and shaped to receive therein a biasing element, the biasing element sized and shaped to urge an indicator element of the latch apparatus to slideably move to expose an indicia surface of the indicator element when the aircraft door latch apparatus is in the latched configuration.

13. A method of operating an aircraft interior furnishing, the method comprising:
latching an aircraft door assembly, the latching including:
magnetically coupling a latch apparatus coupled to a handle of the aircraft door assembly to a door strike coupled to a door frame of the aircraft interior furnishing; and
unlatching the aircraft door assembly, the unlatching including:
magnetically uncoupling the latch apparatus from the door strike;
moving an indicator element of the latch apparatus to expose an indicia surface of the indicator element, the indicia surface indicating an unlatched configuration; and
rotatably moving the aircraft door assembly to expose an interior of the interior furnishing.

14. The method of claim 13 wherein unlatching the aircraft door assembly comprises rotating the handle in a first rotary direction, the rotating magnetically uncoupling the latch apparatus from the door strike.

15. The method of claim 14 wherein rotatably moving the aircraft door assembly includes rotating the aircraft door assembly in a second rotary direction after unlatching the aircraft door assembly, the second rotary direction being opposite to the first rotary direction.
